(19) United States
(12) Patent Application Publication
(10) Pub. No.: US 2023/0229916 A1
(43) Pub. Date: Jul. 20, 2023

(54) SCALABLE TENSOR NETWORK CONTRACTION USING REINFORCEMENT LEARNING

(71) Applicant: NVIDIA Corporation, Santa Clara, CA (US)

(72) Inventors: Gal Chechik, Ramat Hasharon (IL); Eli Alexander Meirom, Haifa (IL); Haggai Maron, Rehevot (IL); Brucek Kurdo Khailany, Austin, TX (US); Paul Martin Springer, Iserlohn (DE); Shie Mannor, Haifa (IL)

(21) Appl. No.: 18/157,608

(22) Filed: Jan. 20, 2023

Related U.S. Application Data
(60) Provisional application No. 63/301,103, filed on Jan. 20, 2022.

(51) Int. Cl. G06N 3/08; G06N 3/045

(52) U.S. Cl. CPC G06N 3/08; G06N 3/045

(57) ABSTRACT

A method for contracting a tensor network is provided. The method comprises generating a graph representation of the tensor network, processing the graph representation to determine a contraction for the tensor network by an agent that implements a reinforcement learning algorithm, and processing the tensor network in accordance with the contraction to generate a contracted tensor network.

### CROSS-REFERENCE TO RELATED APPLICATIONS

This application claims the benefit of U.S. Provisional Application No. 63/301,103 titled “SCALABLE TENSOR NETWORK CONTRACTION USING REINFORCEMENT LEARNING,” filed Jan. 20, 2022, the entire contents of which is incorporated herein by reference.

### BACKGROUND

In quantum computations, a quantum circuit may be simulated as a network of tensors (referred to as a tensor network) on classical computers. Simulating a complex quantum circuit involves computing a contraction of a tensor network. A tensor network is a finite set of multidimensional arrays indexed by a set of shared indices, of which a multidimensional array is referred to as a tensor. A contraction is an operation that combines two tensors with a set of shared indices in a tensor network to generate a product of the two tensors, such that the dimension of the tensor network is reduced by one. Computing the contraction can be executed in a variety of ways, all yielding the same final result, but possibly at very different computational costs. For example, computing the contraction may be analogous to a problem of computing the production of a sequence of matrices ABC. Both (AB)C and A(BC) yield the same result, whereas the computational costs may be very different depending on the matrix dimensions of the matrices ABC. Similarly, the cost of computing the contraction depends heavily on the order by which the tensors in the network are contracted.

Existing techniques suffer from certain limitations. Some techniques may require a huge amount of computation, which is therefore difficult to scale. Some techniques may implement certain algorithms to alleviate the computational cost, however, by making quality-complexity trading-offs, thus often resulting in poor contraction paths and leading to suboptimal choices.

There is a need to provide efficient contraction algorithms to improve the efficiency and performance of the quantum computation.

### SUMMARY

A method, system and computer-readable medium are disclosed herein to implement reinforcement learning for scalable tensor network contraction to achieve an improved performance.

In an exemplary embodiment, the present disclosure provides a method for contracting a tensor network. The method comprises generating a graph representation of the tensor network, processing the graph representation to determine a contraction for the tensor network by an agent that implements a reinforcement learning algorithm, and processing the tensor network in accordance with the contraction to generate a contracted tensor network.

In a further exemplary embodiment, the graph representation comprises nodes and edges connecting the nodes. Each node represents a tensor in the tensor network. Each edge represents a set of shared indices between two tensors in the tensor network.

In a further exemplary embodiment, the contraction is an operation that combines two tensors in the tensor network into a product of the two tensors based on a set of shared indices. Processing the graph representation to determine the contraction for the tensor network by the agent that implements the reinforcement learning algorithm further comprises determining accumulated contraction losses over one or more edges, and determining the contraction corresponding to a minimal accumulated contraction loss. Each accumulated contraction loss is an aggregation of weights on edges corresponding to a corresponding contraction path causing the tensor network to transition from an initial state into a terminal state having no edges therein.

In a further exemplary embodiment, the agent comprises a graph neural network (GNN) used to parameterize a policy of the reinforcement learning algorithm. Determining accumulated contraction losses over the one or more edges further comprises (i) determining a distribution of weights over edges for the graph representation of the tensor network, (ii) sampling the edges by adding weights of the edges to the corresponding accumulated contraction losses and calculating graph representations of the contracted tensor network corresponding to the edges, and (iii) repeating the steps (i) and (ii) until the calculated graph representation in the step (ii) arrives at the terminal state.

In a further exemplary embodiment, the accumulated contraction losses comprise approximate values to estimate losses of a number of contractions in the respective contraction paths.

In a further exemplary embodiment, the agent determines the accumulated contraction losses exceed a threshold value before calculating the number of contractions.

In a further exemplary embodiment, the threshold value is the smallest observed accumulated contraction loss associated with a contraction path.

In a further exemplary embodiment, the method further comprises determining an approximation value to estimate the loss of a number of contractions in the respective contraction loss based on the threshold value.

In a further exemplary embodiment, an off-policy element is applied in the reinforcement learning algorithm to shift the policy adopted therein towards a target policy.

In a further exemplary embodiment, the off-policy element is determined based on samples drawn from an optimistic buffer, the method further comprises retrieving a plurality of data from the optimistic buffer, assigning scores to each of the plurality of data, determining the samples to be drawn from the optimistic buffer based on the distribution of the scores of the plurality of data, determining the off-policy element based on the samples, and updating the policy of the reinforcement learning algorithm.

In a further exemplary embodiment, the method further comprises extracting features from the tensor network, assigning a dynamic range to one or more tails of a distribution, and compressing the dynamic range for the one or more tails of the distribution. The features are associated with the distribution.

In a further exemplary embodiment, the agent further implements a solver, and the solver provides action scores as additional features to be learned by the reinforcement learning algorithm in the agent.

In a further exemplary embodiment, the agent further implements a solver. The solver calculates a number of contractions corresponding to a contraction path, and the reinforcement learning algorithm in the agent calculates the rest of the contractions in the corresponding contraction path.

In another exemplary embodiment, the present disclosure provides a device for contracting a tensor network, which implements an agent. The device comprises one or more processors and a non-transitory computer-readable medium, having computer-executable instructions stored thereon. The computer-executable instructions, when executed by the one or more processors, cause the one or more processors to generate a graph representation of the tensor network, process the graph representation to determine a contraction for the tensor network by the agent that implements a reinforcement learning algorithm, and process the tensor network in accordance with the contraction to generate a contracted tensor network.

In a further exemplary embodiment, the graph representation comprises nodes and edges connecting the nodes. Each node represents a tensor in the tensor network. Each edge represents a set of shared indices between two tensors in the tensor network.

In a further exemplary embodiment, the contraction is an operation that combines two tensors in the tensor network into a product of the two tensors based on a set of shared indices. Processing the graph representation to determine the contraction for the tensor network by the agent that implements the reinforcement learning algorithm further comprises determining accumulated contraction losses over one or more edges, and determining the contraction corresponding to a minimal accumulated contraction loss. Each accumulated contraction loss is an aggregation of weights on edges corresponding to a corresponding contraction path causing the tensor network to transition from an initial state into a terminal state having no edges therein.

In a further exemplary embodiment, the agent comprises a graph neural network (GNN) used to parameterize a policy of the reinforcement learning algorithm. Determining accumulated contraction losses over one or more edges further comprises (i) determining a distribution of weights over edges for the graph representation of the tensor network, (ii) sampling the edges by adding weights of the edges to the corresponding accumulated contraction losses and calculating graph representations of the contracted tensor network corresponding to the edges, and (iii) repeating the steps (i) and (ii) until the calculated graph representation in the step (ii) arrives at the terminal state.

In a further exemplary embodiment, an off-policy element is applied in the reinforcement learning algorithm to shift the policy adopted therein towards a target policy.

In a further exemplary embodiment, the off-policy element is determined based on samples drawn from an optimistic buffer, the computer-executable instructions, when executed by the one or more processors, cause the one or more processors to retrieve a plurality of data from the optimistic buffer, assign scores to each of the plurality of data, determine the samples to be drawn from the optimistic buffer based on the distribution of the scores of the plurality of data, determine the off-policy element based on the samples, and update the policy of the reinforcement learning algorithm.

In yet another exemplary embodiment, the present disclosure provides a non-transitory computer-readable medium for contracting a tensor network. The non-transitory computer-readable medium implements an agent and has computer-executable instructions stored thereon. The computer-executable instructions, when executed by the one or more processors, cause the one or more processors to generate a graph representation of the tensor network, process the graph representation to determine a contraction for the tensor network by the agent that implements a reinforcement learning algorithm, and process the tensor network in accordance with the contraction to generate a contracted tensor network.

In another exemplary embodiment, the reinforcement learning algorithm is trained based on, at least in part, a parameter associated with a processor configured to perform the contraction operation.

In another exemplary embodiment, the processing, by the agent, the graph representation to determine the contraction for the tensor network further comprises providing a memory limit parameter associated with a parallel processing unit as an input to the reinforcement learning algorithm. The parallel processing unit is configured to process the tensor network to perform the contraction.

### BRIEF DESCRIPTION OF THE DRAWINGS

The present systems and methods for architecture-agnostic federated learning are described in detail below with reference to the attached drawing figures, wherein:

FIG. 1A illustrates a system including an agent device and an environment, in accordance with some embodiments.

FIG. 1B demonstrates an exemplary process of determining a contraction for a tensor network using the agent device as shown in FIG. 1A, in accordance with some embodiments.

FIG. 2A illustrates a flowchart of a method for determining an optimal contraction order, in accordance with some embodiments.

FIG. 2B illustrates a flowchart of a method for training an agent to learn contraction losses, in accordance with some embodiments.

FIG. 2C illustrates a flowchart of a method for implementing a trained agent to determine an optimal contraction based on the current state of the tensor network, in accordance with some embodiments.

FIG. 3 demonstrates an exemplary process performed by an agent to contract a tensor network, in accordance with some embodiments.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

FIG. 6A is a conceptual diagram of a graphics processing pipeline implemented by the PPU of FIG. 4 suitable for use in implementing some embodiments of the present disclosure.

FIG. 6B illustrates an exemplary game streaming system suitable for use in implementing some embodiments of the present disclosure.

### DETAILED DESCRIPTION

Systems and methods are disclosed related to finding an optimal contraction order to contract a tensor network, by using Reinforcement Learning (RL) schemes combined with graph neural networks (GNNs), so as to improve the efficiency and reduce the computational cost for, e.g., quantum computing (QC) applications.

The problem of finding an optimal contraction order for a tensor network can be investigated by establishing a state space to estimate all possible states of the tensor network, which could be generated based on the possible sets of contractions in the sequence of contractions (i.e., a contraction path). The RL algorithm is configured to learn how to take a current graph representing the tensor network and pick an optimal contraction (i.e., one step in the sequence of contractions) to perform based on the state of the current graph. The determination of the optimal contraction is guided by a policy of the RL algorithm, which may be parameterized by a GNN. The GNN takes a current graph representing the tensor network as an input and outputs a distribution over the edges to be selected. An edge represents one step in the sequence of contractions that can be performed based on the state of the current graph. The distribution provides weights over the edges that are one step further from the current state of the tensor network towards the terminal state. At a training stage, the edges output from the GNN may be sampled from the distribution yielding possible contracted tensor networks corresponding to the sampled edges. The weights of the sampled edges may be added to corresponding total path costs, where each path includes a sequence of contractions. The process may be repeated until reaching the terminal state, which include no excessive edges for further contraction. As such, the RL algorithm combined with the GNN may be trained to learn losses of the possible sequences of contractions based on the current state of the tensor network. At inference time, an agent trained with the RL algorithm and the GNN can use the knowledge of the total losses over the possible contraction sequences to output a distribution over contraction paths based on the current state of the tensor network. To this end, the agent may predict a contraction path with the minimal total contraction cost so as to determine a step of contraction corresponding to the determined contraction path.

In an embodiment, a tensor network may be represented by a graph structure including nodes and edges. Each node may represent a tensor in the tensor network, while an edge may represent a set of shared indices between two tensors in the tensor network. A weight function may be defined on the edges, which may represent some measures of the time and space complexity of contracting the indices associated with the edges. A graph representation with weighted edges is referred to as a weighted graph.

In an embodiment, the TNCO (Tensor Network Contraction Ordering) problem is formulated as a MDP (Markov Decision Process). The state space of the MDP is defined as the space of all weighted graphs. Various policy search algorithms may be implemented in the RL framework, such as PPO (Proximal Policy Optimization, which is a policy gradient method for RL). The policy may be parameterized by using a GNN, which outputs a distribution over edges connected to each node in a weighted graph in the state space. The action space of the MDP is defined as the space of actions causing transitions from a weighted graph to another in the state space. Hence, each action connects two weighted graphs in the state space, which is related to sampling of an edge in a weighted graph and generation of another weighted graph as a contraction result based on the sampled edge. An accumulated loss for a contraction path may be calculated by aggregating weights of the edges corresponding to a sequence of contractions causing a tensor network at a current state to eventually transition into the terminal state. A trained agent may evaluate the accumulated losses over the edges on the current graph representation to determine a step of contraction to perform.

In an embodiment, the agent may implement path pruning to reduce the computational cost. By applying path pruning, those paths with the accumulated cost exceeding a target value are pruned without performing calculations on all possible states for those paths. In an embodiment, the agent may approximate values after a number of contractions for the remainder contractions in those pruned paths. In this way, the agent may collect sufficient full-path (of the path up to the terminal state) data, so as to better train the value function.

In an embodiment, the agent may implement an off-policy element to an on-policy search algorithm. As an example, an optimistic buffer may be served as the off-policy element applied to the on-policy PPO algorithm, thereby shifting the neural networks (e.g., the GNN) in the agent towards the optimal policy.

Other improvements to the algorithms adopted by the agent include robust feature scaling and leverage of existing solvers in accordance with one or more embodiments.

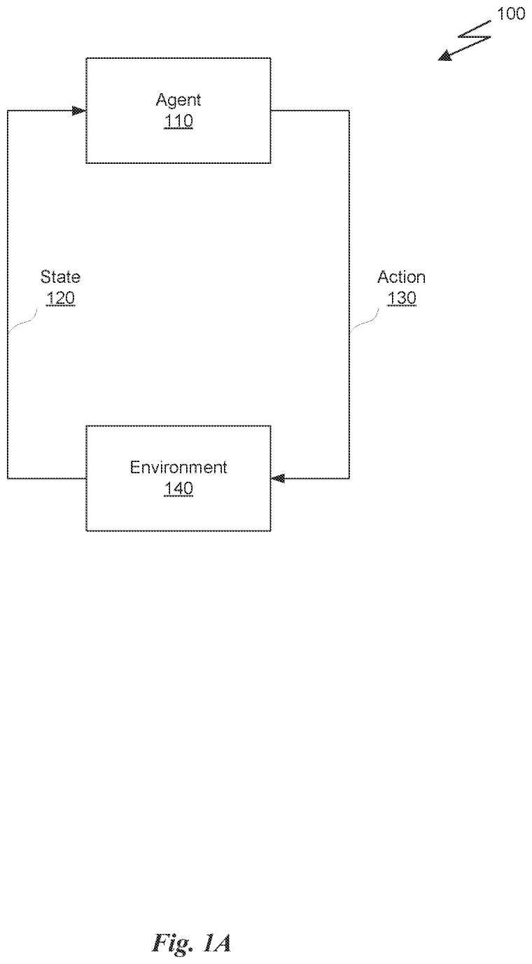

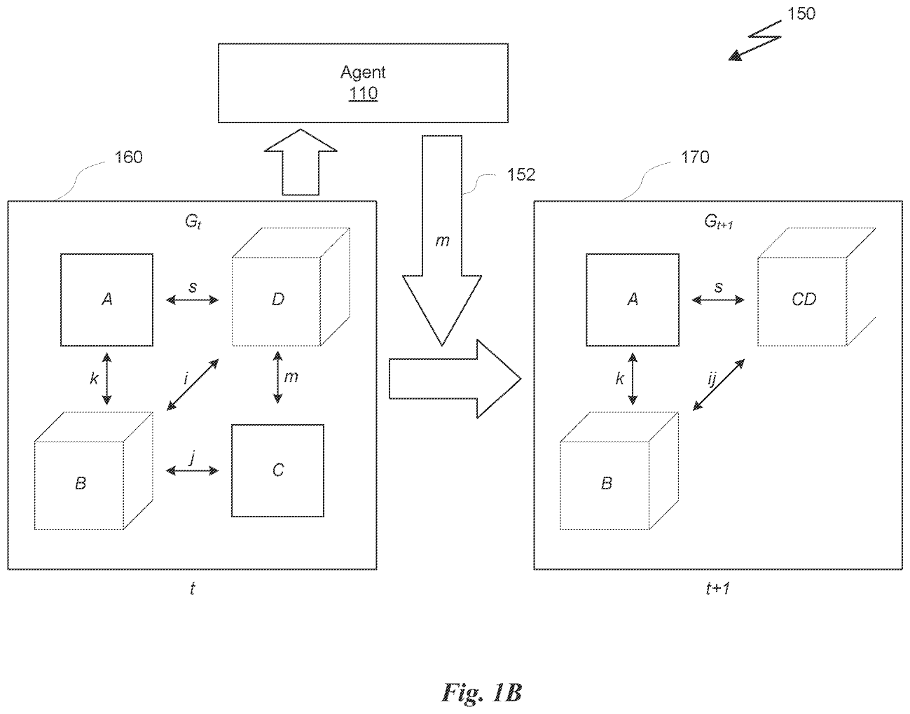

FIG. 1A illustrates a system 100 including an agent 110 and an environment 140, in accordance with some embodiments. The environment 140 is a task or simulation, whereas the agent 110 is an artificial intelligence (AI) algorithm that interacts with the environment 140 and tries to solve it.

The agent 110 may be implemented in a computing system, such as a terminal device (e.g., a personal computer or a smartphone), to process data obtained from the environment 140 and subsequently take actions with respect to the environment 140. In one instance, the environment 140 may be a video game (e.g., a chess game) running on a server or on a computing system implementing the agent 110. The agent 110 may be trained to play the video game. In another instance, the environment 140 may be the natural world (e.g., a workplace) surrounding a computing system (e.g., a robotic or an autonomous car) implementing the agent device 110. The agent 110 may be trained to plan a route for the computing system to move in the workplace. In some variations, the agent 110 may take inputs from the environment 140 through sensors and deliver the output to the environment 140 through actuators, where the sensors and/or actuators may be integrated in or coupled to the computing system.

The environment 140 may be of various types. When the next state of the environment 140 at a given time is predictable, the environment is said to be a deterministic environment, else it is a Stochastic environment. When the environment 140 consists of a finite number of states and agents have a finite number of actions, the environment is said to be a discrete environment. While in a continuous environment, the environment 140 may have an infinite number of states, thus the possibilities of taking an action are also infinite. When an agent 110 is capable to sense or access the complete state of the environment 140 at each point in time, the environment is said to be a fully observable environment, else the environment is partially observable. It should be noted that there may be other types of environments applicable to the techniques described in the present disclosure.

The agent 110 may be trained in the environment 140 or a similar environment by making decisions (e.g., to take actions) and receiving rewards (e.g., positive and negative) in the environment 140. In this way, a trained agent may be able to perceive and interpret the environment 140.

As shown in FIG. 1A, the agent 110 may obtain a state 120 of the environment 140 via an observation process. The state 120 can include a set of parameters that describe aspects of the environment 140. The environment 140 may have a discrete state-space, when the number of all possible states of the environment 140 is finite, in which each of the parameters may be selected from a set of discrete values. Alternatively, the environment 140 may have a continuous state-space, in which each of the parameters may be described by a corresponding continuous function. In a continuous state-space, the number of all possible states is infinite. A computing system implementing the agent 110 may include various hardware and software components to facilitate the observation process. For example, the computing system may include sensors, such as cameras, to acquire images of the environment 140. The agent 110 may adopt RL algorithms to explore possible outcomes based on the state 120 obtained in the observation process so as to determine an action 130 to be applied to the environment 140. The RL algorithms, when adopted by the agent 110, may enable the agent 110 to develop a strategy to determine actions as a function of the state 120 and the environment 140, for example, by exploring possible future outcomes (e.g., future states) with a number of steps ahead of the state 120. A function that returns a feasible action (e.g., the action 130) for a current state (the state 120) may be referred to as a policy. The policy may be initially formed based on a search algorithm and then be updated during the training of the agent 110. The agent 110 may be trained by rewarding desired behaviors (e.g., actions) and/or punishing undesired ones. The agent 110 may repeat the aforementioned observation process followed by one or more additional actions to interact with the environment 140. The processes described above may be utilized in a training phase as well as an inference phase. In some variations, both on-policy and off-policy learning algorithms may be adopted by the agent 110 to interact with the environment 140. The former is also referred to as a behavior policy, which is used by the agent 110 to select an action 120. The latter is a policy that is different from the behavior policy. In some examples, off-policy methods uses a target policy to improve the behavior policy of the agent 110, in view of a distribution mismatch between the two polices.

In some examples, the state 120 of the environment 140 or the properties thereof may be represented by a tensor network. The environment 140 may be a tensor network contraction ordering (TNCO) problem, in which the order of tensor contractions is to be determined.

Tensors are mathematical objects that can be used to describe physical properties, such as the stress on a material. The concept of tensors is a generalization of the scalars (as tensors with zero dimension), vectors (as tensors with one dimension), and matrices to an arbitrary number of dimensions. The number of dimensions of a tensor is defined as the rank of the tensor, which is associated with the number of indices in the tensor, for example, scalars having no indices, vectors having exactly one indices, and matrices having an arbitrary number of indices. The length in each dimension describes the shape of a tensor.

Tensor networks may represent sets of correlated data. A tensor network includes a number of tensors, in which correlations between tensors are described by sets of shared indices. Tensor networks have been studied in quantum physics, chemistry, applied mathematics, and many other fields, to investigate various applications, such as modeling multimodal data, simulating quantum circuits, etc. Because tensor networks can be mapped to quantum circuits, tensor network machine learning can be deployed and the models of which can be trained on quantum hardware (e.g., quantum computers).

During the computation, tensor networks can be contracted to reduce the dimensions of the data. A contraction is an operation that combines two tensors with a set of shared indices in a tensor network to generate a product of the two tensors, such that the dimension of the tensor network is reduced by one. As mentioned-above, the cost of computing the contraction depends heavily on the order by which the tensors in the network are contracted. The agent 110 may be trained to solve the TNCO problem, as shown in FIG. 1A.

FIG. 1B demonstrates an exemplary process 150 of determining a contraction for a tensor network using the agent 110, as shown in FIG. 1A, in accordance with some embodiments. The agent 110 may repeat the process 150 as demonstrated in FIG. 1B to cause the tensor network at a current state to eventually transition into a terminal state (e.g., having no shared indices).

As demonstrated in FIG. 1B, the tensor network at each step (e.g., the steps t and t+1) is represented by a graph representation (e.g., Gₜ and Gₜ₊₁). The graph representation may include nodes and edges. Each node may represent a tensor in the tensor network. Each edge may represent a set of shared indices between two tensors in the tensor network.

In this example, at step t, the graph representation Gₜ as shown in block 160 includes four nodes representing four tensors, which are referred to as tensors A, B, C, and D. The correlation between the tensors in the tensor network are represented by five edges, corresponding to indices i, j, k, m, and s, respectively. At step t, the tensor network can be contracted by combining two tensors associated with any of the five indices. The agent 110 may take the graph representation Gₜ at step t as input and may determine an optimal contraction associated with index m (as shown in arrow 152) to perform. Block 170 illustrates the resulting tensor network at step t+1, which is represented by the graph representation Gₜ₊₁. The dimension of the resulting tensor network is reduced by one compared to the tensor network in step t, since the tensors C and D in Gₜ are combined to generate a product CD in Gₜ₊₁. Moreover, the edges in the tensor network are reduced from five in Gₜ to three in Gₜ₊₁, one of which now includes a set of two shared indices (i.e., indices i and j).

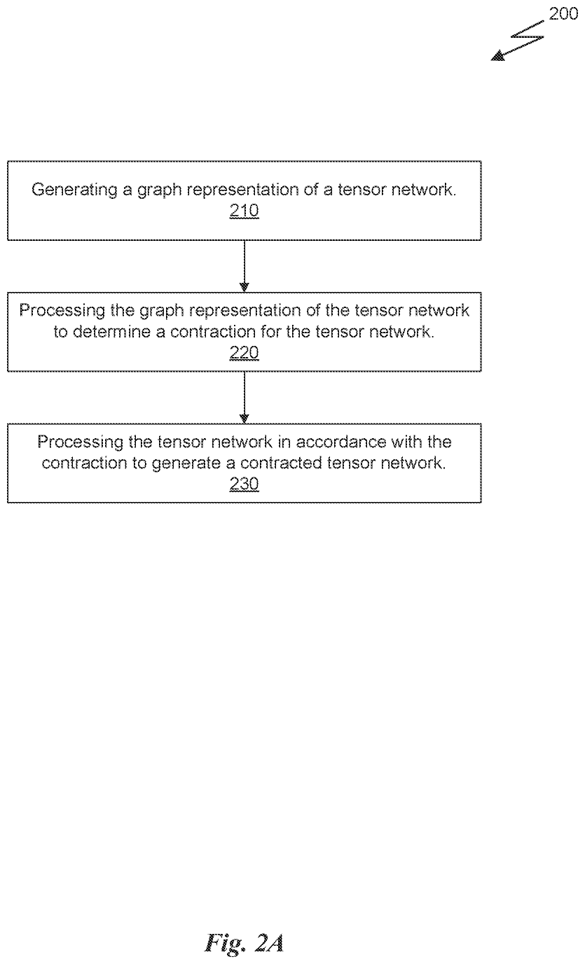

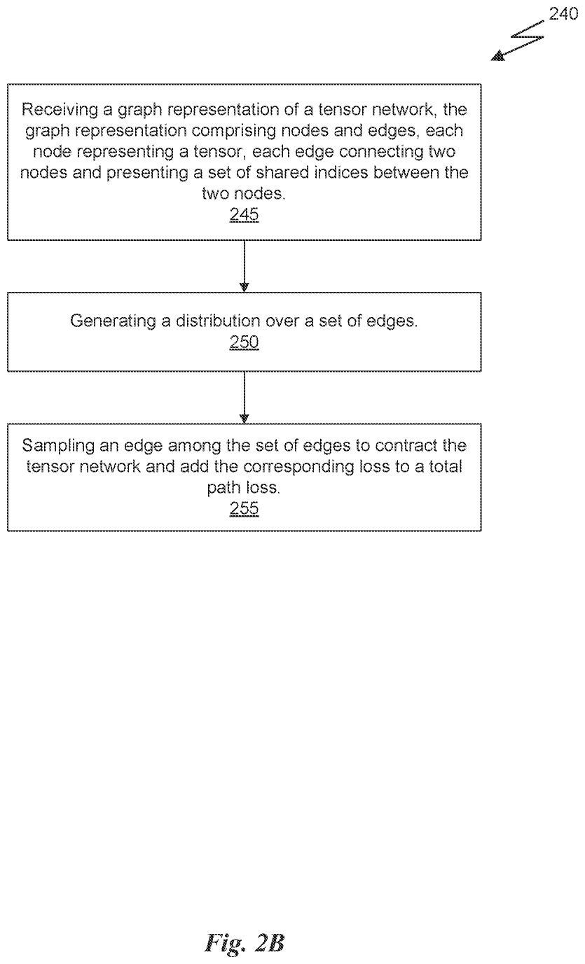

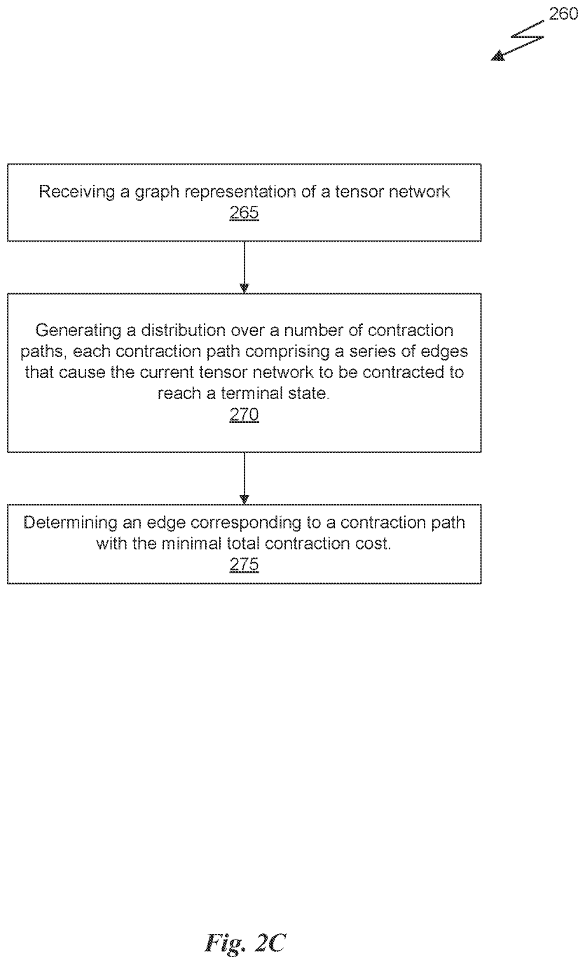

FIG. 2A illustrates a flowchart of a method 200 for determining an optimal contraction order, in accordance with some embodiments. The method 200 may be performed by a computing system implementing the agent 110 as demonstrated in FIG. 1A/1B. It will be recognized that the method 200 may be performed in any suitable environment and that any of the blocks in FIG. 2A may be performed in any suitable order.

At step 210, the computing system generates a graph representation of a tensor network. The graph representation may be generated based on the current status of the tensor network. For example, the graph representation of the tensor network may be Gₜ in block 160 as shown in FIG. 1B.

At step 220, the computing system processes the graph representation of the tensor network to determine a contraction for the tensor network. The processing of the graph representation may be performed by the agent 110, which is implemented in the computing system. As demonstrated in FIG. 1B, the agent 110 may take the graph representation of the tensor network as input and determine a contraction associated with one set of shared indices based on the graph representation.

The agent 110 may be trained by adopting different setups. In one setup, the agent 110 may be trained on a single network. A network herein refers to a tensor network. This setup is suitable for optimizing large networks, which is typically done once, for example, as in quantum-supremacy tests. The agent 110 may repeatedly contract the same network and learn to find optimal contraction paths. In another setup, the agent 110 may be trained on a set of training networks, thereby learning to find optimal contraction paths for networks different from yet similar to the training networks at inference time. For instance, the new networks may be taken from the same distribution as the training networks. The agent 110 may adopt an RL algorithm(s) combined with graph neural networks (GNNs) to facilitate the learning process, which will be described in detail hereinafter.

At step 230, the computing system processes the tensor network in accordance with the contraction to generate a contracted tensor network. As demonstrated in FIG. 1B, the computing system may contract the tensor network by combining two tensors corresponding to the set of shared indices (e.g., represented by m) to generate a product of the two tensors, such that the dimension of the contracted tensor network is reduced by one.

The following establishes a mathematic model of a generic TNCO problem to be solved by the agent 110, in accordance with some embodiments.

A tensor, denoted by a capitalized letter (e.g., “A”), is a multi-dimensional array of numbers indexed by a subset of a finite symbolic index set, [symbol] _{A}⊆ [symbol] ={i, j, . . . }. A valid range may be defined for each index i∈ [symbol] , for example, i∈{1, . . . , l} may be referred to as the extent of the index. Pairwise tensor contraction is a common binary operation defined on pairs of tensors. Formally, the contraction of tensors A and B may be a new tensor [symbol] , indexed by the symmetric difference of the index sets [symbol] _{A}Δ [symbol] _{B}:=( [symbol] _{A}∪ [symbol] _{B})\( [symbol] _{A}∩ [symbol] _{B}), the values of which are defined by the following summation on the intersection of the index sets,

[symbol]

[symbol]

_{_{A}}_{Δ} [symbol] _{_{B}}=Σ [symbol] _{_{A}}_{∩} [symbol] _{_{B}}A [symbol] _{_{A}}·B [symbol] _{_{B}}, (Eq. 1)

where A [symbol] denotes the indexing of a tensor by the indices in [symbol] , B [symbol] denotes the indexing of another tensor by the indices in [symbol] , and Σ [symbol] represents summation over all the indices in [symbol] . In other words, the tensor contraction operation is indexed by the indices that appear in only one of the tensors. The values in the one tensor are a summation over all shared indices. A matrix multiplication is demonstrated as an example of tensor contraction. In the example, a matrix A is indexed by [symbol] _{A}={i, k} and a matrix B is indexed by [symbol] _{B}={k, j}. The contraction [symbol] (A, B) is a tensor indexed by [symbol] _{A}Δ= [symbol] _{B}={i, j}, and is defined as [symbol] (A,B)_{i,j}=Σₖ₌₁^{K}A_{i,k}B_{k,j}, which coincides with matrix multiplication.

A tensor network T is a representation of a tensor contraction problem. Formally, a tensor network is a collection of n tensors {A^{k}}ₖ₌₁^{K}A_{i,k}B_{k,j}, where each tensor is indexed by subsets of an index set [symbol] _{A}⊆ [symbol] . A tensor network can be represented by a graph structure G=(V, E, w). A set of nodes V represent a set of tensors {A^{k}}ₖ₌₁ⁿ in the tensor network T. The connectivity between the nodes in the graph structure is defined according to the shared index structure, by edges e_{kk′}∈E, if [symbol] ₖ∩ [symbol] _{k′}≠Ø. A weight function is defined on edges by w: E→ [symbol] ₊. The weight function represents some measure of the time or space complexity of contracting the indices associated with the edge and is usually a function of the relevant extents. In some embodiments of the present disclosure, w represents the number of flops needed to execute a contraction, which is proportional to product of the extents of the shared indices by both tensors.

The contraction of a tensor network is a direct generalization of the binary contraction defined in Equation 1 to a collection of tensors, expressed by

[symbol]

(A¹, . . . Aⁿ) [symbol] _{_{distinct}}=Σ [symbol] _{_{shared}}A [symbol] _{₁}¹. . . A [symbol] _{ₙ}ⁿ, (Eq. 2)

where [symbol] _{shared} is a subset of [symbol] , which holds indices that appear twice in the collection of tensors A¹, . . . , Aⁿ, and [symbol] _{distinct} is a subset of [symbol] , which holds indices that appear only once in the collection of tensors and [symbol] _{distinct}=∪ [symbol] ᵢ\ [symbol] _{shared}.

Executing the contraction in Equation 2 directly by using nested loops over all indices is severely inefficient due to the exponential complexity of the execution procedure. A more efficient approach is to execute the contraction as a sequence of edge (or pairwise) contractions. A contraction path is defined as P=(e₁, . . . , eₙ₋₁), eₜ∈Eₜ. A corresponding sequence of graphs are defined as (G₁, . . . , Gₙ). The contraction starts at an initial state where G₁=G. Then, each subsequent contraction yields a new graph Gₜ∈(G₁, . . . , Gₙ). Gₙ may be referred to as a terminal/final state. The series of steps in the contraction path may be referred to as an episode. At each step t, a pair of tensors connected by the edge eₜ=( [symbol] , [symbol] ) is contracted according to Equation 1, where [symbol] , [symbol] represented the pair of tensors. A new tensor network is represented by Gₜ₊₁=(Vₜ₊₁, Eₜ₊₁, wₜ₊₁), which is defined by removing the two contracted tensors [symbol] , [symbol] and adding the resulting tensor Tₜ₊₁ to Vₜ₊₁. The adjacency structure may be defined according to the shared indices as described above; i.e., all edges that have previously been connected to either [symbol] or [symbol] will be connected to Tₜ₊₁ instead.

The agent 110 may be configured to evaluate contraction costs to solve the TNCO problem. The total contraction cost c may be defined as the sum of weights of the contraction sequence,

c(P)=Σₜ₌₁ⁿ⁻¹wₜ (Eq. 3)

The goal in the TNCO is to find a sequence of edge contractions P with a minimal cost, namely:

P*(G)=argmin_{P}c(P), (Eq. 4a)

s.t.P=(e₁, . . . ,eₙ),eₜ∈Eₜ, (Eq. 4b)

where “s. t.” stands for “subject to.”

In an embodiment, the TNCO problem is formulated as a Markov decision process (MDP), which is a discrete-time stochastic control process. The state and action spaces, as well as the transition dynamics and the cost function in the MDP are defined as follows. It will be noted that both costs and rewards may be used for the purpose of training. To illustrate, in this example, costs are adopted in the RL framework.

The state space, denoted as [symbol] , is the space of all weighted graphs, where [symbol] ={G=(V, E, w)}. The state space may be a very large space, which provides a sufficient statistic to evaluate the dynamics of every action. Furthermore, the above-defined state space may enable generalization over states, that is generalization over graphs in embodiments of the present disclosure. The action space is denoted as [symbol] . The actions available in a given state are defined as a set of edges E, which naturally varies from one state (e.g., graph) to another. The transitions in the TNCO problem are deterministic and are defined as [symbol] (G, e), which takes as input the current state G and an edge e∈E, and outputs a new graph. The new graph represents the tensor network after contracting the edge e. An immediate cost for an action e, denoted as [symbol] (G, e), is the weight of the edge w(e). The object of the agent 110 is to find an optimal contraction sequence to minimize the overall cost.

As mentioned above, the agent 110 may be trained using different learning setups, such as a single-network learning setup or a multi-network learning setup. An agent to be trained (e.g., the agent 110) may be denoted as H.

In a single-network learning setup, the goal is to look for an agent H in the class of agents [symbol] , of which edge contraction choices yield an optimal contraction sequence. In this setup, the training object is to solve the following optimization problem, described as

[symbol]

c(P), (Eq. 5a)

s.t.P=(e₁, . . . ,eₙ₋₁),eₜ∈Eₜ, (Eq. 5b)

eₜ=H(Gₜ),t=1, . . . ,n−1. (Eq. 5c)

In a multi-network learning setup, the agent H is trained on multiple input graphs {Gⁱ}ᵢ₌₁^{m}, which may be sampled from an underlying tensor network distribution. Once trained, the agent H may be tested on unseen target graphs from the same distribution. In this setup, the training object is described as,

[symbol]

Σᵢ₌₁^{m}c(Pⁱ), (Eq. 6a)

s.t.Pⁱ=(e₁ⁱ, . . . ,eₙ₋₁ⁱ), (Eq. 6b)

eₜⁱ=H(Gₜⁱ),t=1, . . . ,nⁱ⁻1. (Eq. 6c)

Applying a RL framework to the TNCO problem raises the following challenges that need to be addressed.

A first challenge is related to the wide dynamic range. The contraction costs and tensor sizes typically vary across many orders of magnitudes. Deep neural networks are hard to train when costs are highly variable. Importantly, naive normalization does not address this problem. When the distribution of costs remains strongly unbalanced, normalizing by any constant quantity, such as the max or median, washes out the signal in (at least) one end of the feature-value distribution.

A second challenge is related to the huge search space. The number of possible contraction paths in a TNCO problem is usually enormous. Even among very large action and state spaces, the TNCO problem is an outlier. For comparison, the average length of an episode in a game of GO (as described in Silver, D., Schrittwieser, J., Simonyan, K., Antonoglou, I., Huang, A., Guez, A., Hubert, T., Baker, L., Lai, M., Bolton, A., et al. (2017), “Mastering the game of go without human knowledge,” Nature, 550(7676):354-359) is 200, and so is the action space (branching factor). In a TNCO problem based on a modern quantum circuit, the action space and the length of an episode can reach O(1000) steps and actions. Therefore, the number of possible trajectories in TNCO is hundreds of orders of magnitude larger than that of GO.

A third challenge is related to slow convergence due to heavy-tailed cost distribution. Nearly all research in RL is based on the assumption that the immediate cost has a sub-Gaussian distribution. For approaches based on stochastic approximation, such as Q-learning or policy gradient, a bounded second moment is needed. In TNCO, the reward typically has a heavy-tailed behavior, with its empirical distribution resembling a log-normal distribution. This implies that the variance is expected to be very large even if finite. Moreover, this phenomenon becomes worse as the networks become larger. Studies have shown that if the reward distribution is not sub-Gaussian, the convergence time is | [symbol] |^{α}, α>1, where α is a function of the highest moment of the distribution that converges. Consequently, the TNCO problem suffers from a huge state space and a heavy-tailed reward distribution, and therefore vanilla policy gradient algorithms (which use on-policy value functions) are unlikely to converge in a reasonable time.

A fourth challenge is related to incorporation of existing solvers. Existing meta-heuristic approaches and learning-based approaches have complementary strengths. Existing solvers can often find the optimal solution for small problems (in terms of computational complexity). Learning-based methods usually only approximate the optimal solution, but work well on large problems. The challenge is to enjoy the benefits of the two approaches.

A fifth challenge is related to credit assignment problem. In TNCO, as in other combinatorial optimization problems, early decisions can have a crucial effect on the overall trajectory cost. TNCO's lengthy episodes compared to many other RL problems exacerbate the credit assignment problem.

In view of the foregoing challenges, the agent 110 adopts a RL framework, denoted as RL-TNCO, to solve the TNCO problem. Tensor networks are represented as graphs and a GNN is used to parameterize the policy adopted in the RL-TNCO framework. Each graph is associated with a tuple, expressed by

(X,Y,Z,g), (Eq. 7)

where X∈{0,1}^{n×m} is the adjacency matrix of the tensor network, Y∈ [symbol] ^{n×d} is a node feature matrix that holds features for each tensor, Z∈ [symbol] ^{m×d′} is an edge feature matrix, and g∈ [symbol] ^{d″} is a global graph feature vector, m is the number of edges in the tensor network, and d, d′, d″ are arbitrary feature dimensions. In some examples, constant input features may be applied for node and global features; i.e., Y=[1, . . . , 1], g=[1]. The edge features of an edge e=( [symbol] , [symbol] ) are associated with (1) the contraction cost, (2) the edge's extension (which is the product of the extents of the associated indices), and (3) the greedy score of the edge e=( [symbol] , [symbol] ) based on a heuristic approach in OPT-Einsum (described in Daniel, G., Gray, J., et al. (2018), “Opt [symbol] einsum-a python package for optimizing contraction order for einsum-like expressions,” Journal of Open Source Software, 3(26):753, the entire contents of which is incorporated herein by reference). According to Daniel et al., [symbol] I(i)+ [symbol] I(i)− [symbol] I(i), where I(i) is the extent of index i.

In some instances, the GNN model may be composed of a number of message passing layers, and may maintain learnable node, edge, and global graph representations. Each of the message passing layers may include multilayer perceptrons (MLPs). The message passing layers may be defined as L^{k} ∘ . . . ∘ L¹, where each Lⁱ updates all the representations by performing,

Yⁱ⁺¹,Zⁱ⁺¹,gⁱ⁺¹=Lⁱ(X,Yⁱ,Zⁱ,gⁱ;θⁱ), (Eq. 8)

where θⁱ represents the parameters of the MLPs used in a layer Lⁱ, which may be the only learnable parameters in the GNN model. Each layer Lⁱ may update the features sequentially, by first updating node and edge features by aggregating local information, and then updating the global feature by aggregating over the entire graph. At the last layer, i.e., i=k, edge features may be extracted using a single dimension (i.e., d′=1). A normalization function may be applied over edge scores, denoted as s(e) (as described in Meirom, E., Maron, H., Mannor, S., and Chechik, G. (2021), “Controlling graph dynamics with reinforcement learning and graph neural networks,” International Conference on Machine Learning, pages 7565-7577, PMLR, the entire contents of which is incorporated herein by reference). According to Meirom et al.,

$$P r ( e ) = \frac{{s}^{′} ( e )}{{\sum }_{e} {s}^{′} ( e )} , \qquad ( Eq . 9 a )$$

$${s}^{′} ( e ) = s ( e ) - {min}_{{e}^{′}} s ( {e}^{′} ) + ϵ , \qquad ( Eq . 9 b )$$

where e′ is an index that spans over all the edges, and s′ (e) is a function defined using the score s(e). Equations 9a and 9b provide distribution Pr(⋅) over the edges, which may be used for sampling an edge.

In tensor network contraction, after two tensors in the tensor network are contracted, a new tensor is formed. The new tensor may be bigger in size (based on a total number of entries in the tensor) than the two “parent” tensors that were combined via the contraction. As such, the required memory to store all the intermediate tensors might grow and exceed the available memory in the system (e.g., a GPU memory).

One technique for dealing with the issue of having a finite limit of memory capacity available to perform the contraction is to “slice” the tensor network. Slicing the tensor network refers to a technique by where a set of indices from the input tensor network are omitted. For example, given input indices {i=1, . . . , I; j=1, . . . , J; . . . } of the input tensor network, the intermediate tensor sizes can be reduced by omitting one or more of the input indices during the contraction operation to generate an intermediate contraction result. However, this means that the contraction operation will have to be repeated I⋅J ⋅ . . . times, once for each of the omitted indices, to generate all of the intermediate contraction results. Conceptually, this is similar to fixing the omitted index to a particular index value for each iteration of the contraction operation to generate one of the intermediate contraction results. The fixed indexes are then incremented for the next iteration. The intermediate contraction results can then be combined to generate the resulting product tensor in the tensor network.

Because the memory capacity limit can affect how efficient a tensor contraction operation is to perform, it can be beneficial to select an edge that results in a contraction operation that is below this limit over a different edge that results in a contraction operation that requires slicing the tensor network. In an embodiment, the agent is trained, at least in part, based on an arbitrary memory limit parameter. Rather than training the reinforcement learning algorithm in accordance with the distribution given by Equation 9a, the reinforcement learning algorithm can be trained to learn the distribution P_{θ}(e, Gₜ, MemoryLimit), which gives the distribution over the edges based on an arbitrary MemoryLimit parameter. The variable θ refers to the trainable parameters of the GNN, e is the selected edge, Gₜ is a representation of the intermediate tensor network at time t, and the MemoryLimit parameter is the memory limit of a system or processor in the system, such as the local memory of a parallel processing unit. During inference, the agent 110 may use an available memory limit parameter of a processor that will perform the contraction operation to adapt different policies based on the capacity of the system performing the contraction operation.

For example, relevant quantities in the input to the reinforcement learning algorithm can be normalized based on the memory limit parameter, such that training and inference using the reinforcement learning algorithm is performed in accordance with ratios such as, e.g., tensor size divided by the memory limit parameter, where tensor size is given as the product of the extents of each dimension of the tensor. In some embodiments, the reinforcement learning algorithm can also be trained over different memory limits as well, such that two or more sets of trained parameters of the GNN can be stored for use with different systems having different memory limits. In such embodiments, the GNN can be configured to output both a distribution over the edges and, for each edge, a probability p, where the corresponding edge is contracted with a probability p. When the agent 110 generates the output, the agent 110 uses the probability p to determine whether to contract a selected edge or slice the edge in accordance with a set of indices of the edge. The final output of the agent is constructed incrementally, over a number of iterations, where in each iteration either an edge is added to the contraction path, or an index from the edge is selected and added to a set of slicing indices. The contraction operation may then be performed in accordance with the contraction path, incorporating the slicing technique for any edge that may need to be sliced to reduce the memory size required for the contraction operation.

In some examples, the agent 110 may implement multiple GNNs. A first GNN may have an architecture defined by Equations 7-9b to perform sampling (or selection) of edges, which may be referred to as an actor network. A second GNN may share the same architecture in the first GNN, on top of which a final pooling layer over the nodes (e.g., the nodes in a GNN layer) may be added to obtain a value function, which may be used for computing the updated policy. The second GNN may be referred to as a critic network.

FIG. 2B demonstrates an exemplary method 240 for training an agent to learn contraction losses. The method 240 may be performed by a computing system implementing the agent 110 as demonstrated in FIG. 1A/1B. It will be recognized that the method 240 may be performed in any suitable environment and that any of the blocks in FIG. 2B may be performed in any suitable order.

At step 245, the agent 110 receives a graph representation of a tensor network. The agent 110 may implement the above-described RL-TNCO framework.

At step 250, the agent 110 generates a distribution over a set of edges, for example, according to Equations 9a and 9b.

At step 255, the agent 110 samples an edge among the set of edges to contract the tensor network and adds the corresponding loss to a total path loss.

The agent 110 may repeat steps 245 through 255 for a number of iterations until the agent 110 learns the total path loss for an episode, which includes a sequence of edge contractions P, as shown in Equation 5b or 6b. The total path loss for the corresponding sequence of edge contractions (or the episode) may be stored in a buffer and can be updated through a number of iterations.

In the training stage, the agent 110 may run a large number of episodes to learn total path losses for different contraction paths and/or to update the distributions over the edges in the graph representations of the tensor network. As a result, the agent 110 may learn to predict a distribution over the edges, which indicates total contraction costs for possible contraction paths. In this way, the trained agent 110 may be used to predict an edge to achieve an optimal contraction based on an input tensor network.

FIG. 2C demonstrates an exemplary method 260 for using a trained agent to determine an optimal contraction path. The method 260 may be performed by a computing system implementing the agent 110 that is trained by performing the method 240 and possibly in combination of other processes described in the present disclosure. It will be recognized that the method 260 may be performed in any suitable environment and that any of the blocks in FIG. 2C may be performed in any suitable order.

At step 265, the agent 110 receives a graph representation of a tensor network. This step is similar to the above-described step 245 in method 240 as shown in FIG. 2B.

At step 270, the agent 110 generates a distribution over a number of contraction paths. Each contraction path includes a series of edges indicating a sequence of contractions. The sequence of contractions, when applied to the tensor network received from step 265, may cause the tensor network to be transitioned into a terminal state.

At step 275, the agent 110 determines an edge corresponding to a contraction path with the minimal total contraction cost. In particular, the agent 110 may first determine an optimal contraction path with the minimal total contraction cost based on the distribution generated in step 270, and then determine an edge corresponding to the optimal contraction path. The computing system may decide to perform a contraction based on the determined edge for the tensor network as received in step 265.

The computing system may repeat steps 265 through 275 for a number of iterations until no edges exist in the resulting tensor network.

In an embodiment, the agent 110 may implement path pruning to restrict the search space established in a RL-TNCO framework thereby reducing the computational complexity. The contraction costs in the TNCO problem may be defined to be strictly positive. When running each episode, the agent 110 may update the accumulated contraction loss after each contraction. The accumulated contraction loss may be stored in a designated buffer in the computing system. In some examples, the agent 110 may discover that a current accumulated contraction loss at some point exceeds a threshold value, such as the smallest observed accumulated contraction cost (referred to as C^{min}) corresponding to a different contraction path that has been computed/estimated. As such, the agent 110 may decide to prune one or more paths associated with the current contraction cost, because the one or more paths cannot be optimal. The one or more paths may share the same series of contractions that have been computed by the computing system to obtain the current contraction cost.

The path pruning may be implemented in both the training stage and the inference stage. In the inference stage, the trained agent 110 may choose to prune (or abandon) the current contraction path and to re-select another contraction path. In the training stage, the agent 110 may combine the path pruning with other method(s). In an embodiment, the agent 110 may implement the path pruning during a path-collection phase. If the vast majority of paths were pruned in this phase, the agent 110 would not be able to collect sufficient data to learn about total contraction losses for different contraction paths. Therefore, the agent 110 may apply other method(s) to estimate a contraction loss for the rest of the contraction path up to the termination point (e.g., the terminal state of the tensor network) for each pruned path. In the RL-TNCO framework, the agent 110 may estimate a future expected return at the terminal state of the tensor network by using the value function estimated in the RL-TNCO framework. The estimation of the future expected return and/or the value function can be more accurate when the agent 110 collects sufficient full/completed trajectories (i.e., contraction paths). In a further embodiment, the agent 110 may use the critic network to learn to approximate the value/value function at the tail of the trajectory (e.g., for the last few contractions in a contraction path). In some variations, when applying path pruning in the training of the agent 110, most trajectories in the RL-TNCO framework may terminate prematurely, thereby causing the approximation of the value function at the terminal state to be inaccurate. To this end, the agent 110 may approximate a terminal value after performing l number of contractions and deciding to prune the current path. The terminal value may be calculated as,

$$min C ( G , e ) + ( \frac{{C}_{l}}{l} + \frac{{C}^{min}}{n} ) \cdot \frac{n - l}{2} , \qquad ( Eq . 10 )$$

where C^{min} is the smallest observed accumulated contraction cost for a full trajectory, Cₗ is the accumulated contraction loss for the l number of contractions, n is the total number of contractions for a full trajectory. The last term

$$( \frac{{C}_{l}}{l} + \frac{{C}^{min}}{n} ) \cdot \frac{n - l}{2}$$

in Equation 10 averages the mean known cost per step

$$( \frac{{C}^{min}}{n} )$$

and the mean cost per step of the current trajectory

$$( \frac{{C}_{l}}{l} ) .$$

By ways of implementing the approximation for the terminate value, the agent 110 may apply the path pruning to improve computational efficiency and yet may still be able to collect sufficient full-trajectory data, so as to improve the training performance (e.g., by obtaining a more accurate value function).

In an embodiment, the agent 110 may implement an off-policy element to an on-policy search algorithm. The on-policy search algorithm may be the policy learned by the agent 110 through training. In this embodiment, the agent 110 may apply an optimistic buffer, which serves as an off-policy element, to the policy of the agent 110, thereby shifting both the actor and critic networks (e.g., the actor and critic GNNs) in the agent 110 towards an optimal policy. The on-policy algorithm may use a rollout buffer to store related information, such as the calculated value function associated with the on-policy.

In some examples, the agent 110 may add the optimistic buffer to the on-policy PPO algorithm as an off-policy element. An optimistic buffer may be defined as containing tuples (G, w(e), e, C(G, e)). In standard reinforcement learning notation, G≡s, w(e)≡r, e≡a, where s is a state, r is a reward, and a is an action. C(G, e) is the total empirical accumulated cost from the state after performing the action e, as logged from a specific trajectory. Furthermore, C(G, e) is a pessimistic estimation of the optimal value function (denoted as V^{opt}(G)), as the optimal value function is the maximal accumulated reward over all trajectories from G. During the training, the agent 110 may update the optimistic buffer after each training iteration. The agent 110 may routinely retrieve information from either the rollout buffer or the optimistic buffer as samples. For each sample such that V(G)>C(G, e), the agent 110 may assign a score that is calculated by V(G)−C(G, e). For all other samples such that V(G)≤C(G, e), the agent 110 may assign a score of zero, thereby effectively eliminating these samples. Then, the agent 110 may sample b samples according to the normalized score distribution based on the assigned scores, where b may be defined as the size of the optimistic buffer. The agent 110 may update the GNNs (e.g., the actor/critic network) by using PPO loss with the samples drawn from the optimistic buffer. As a result, an off-policy bias may be applied to shift both the actor and critic networks towards the optimal policy.

In the RL-TNCO framework setup, good paths (with reasonable computational costs) are expected to be very rare. Even when the agent 110 encounters a good path, the agent 110 may be overwhelmed by poor trajectories, because the information is often washed out by negative path updates, leading to slow convergence. Furthermore, deep policy gradient algorithms often apply gradient clipping, thus limiting the effect of the highly valuable but very rare trajectories. The agent 110 may use an optimistic buffer to overcome the above-identified problem and/or address the issue of slow convergence rate of a policy gradient algorithm if adopted in the RL-TNCO framework setup.

Other improvements to the algorithms adopted by the agent include robust feature scaling and leverage of existing solvers in accordance with one or more embodiments.

In an embodiment, the agent 110 may implement a scheme to achieve a robust feature scaling, thereby addressing the above-mentioned challenge of the wide dynamic range. The scheme may include two transformations to each input feature to assign high dynamic range to the tails and a transformation to compress the dynamic range of the heavy-tail distribution. The former two transformations may be applied to enhance the dynamic range at the distribution tails. The latter transformation may be a logarithmic transformation to achieve the compression.

The transformations in the scheme may be applied to every feature. The vector y_{z} is a column vector of the edge feature matrix Z. If all the values in the vector y_{z} have the same sign, the agent 110 may obtained the scaled feature of the feature z by computing log(abs(y_{z})), otherwise log(y_{z}−min(yₓ)+1). Furthermore, the agent 110 may use the median m of y_{z} as a “border” to separate high and low ranges. For example, each column of the edge feature matrix Z may be scaled as

$$\frac{{y}_{z} - m}{h ( {y}_{z} ) - m} ,$$

where h(⋅) is the scale of the high and/or low ranges, e.g., h(⋅)=max(⋅), min(⋅) In some instances, the high and low regimes may be clipped to [−100, 100].

In an embodiment, the agent 110 may implement existing solvers to work with the RL-TNCO framework. In some instances, the agent 110 may implement a solver that is based on action scores, e.g., a greedy approach, by incorporating the scores provided by the solver as additional features that the RL-TNCO framework can learn to use. In some variations, the agent 110 may use a fast solver to optimize part of a problem. For example, when solving a large TNCO problem, the agent 110 may use a greedy approach to find a prefix of the contraction path using the low-cost contractions and then use RL to find the remaining steps in the contraction path. In a further example, RL may spend optimization cycles on the most important (heavy) late-stage contractions.

In a further embodiment, the above-mentioned credit assignment challenge may be addressed through the use of a general-purpose RL scheme with sufficient compute power.

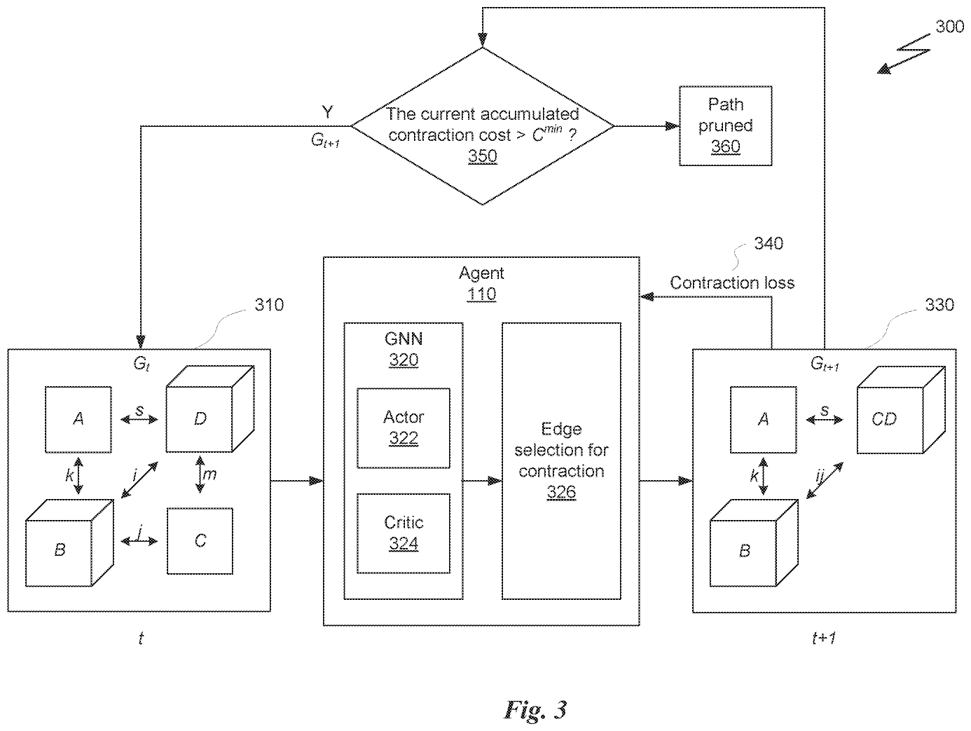

FIG. 3 demonstrates an exemplary process 300 performed by the agent 110 to contract a tensor network. The process 300 may be performed by a computing system implementing the agent 110 as demonstrated in FIG. 1A/1B during training or inference. It will be recognized that the process 300 may be performed in any suitable environment and in combination with any other method/process described in the present disclosure.

The agent 110 may include multiple GNNs 320, which take graph representation of a tensor network (G) 310 as input. As described-above, the graph representation of the tensor network (G) 310 are defined with nodes (for tensors) and edges (for shared indices). The GNNs 320 may include an actor network 322 and a critic network 324. The actor network 322 may generate a distribution over edges based on the input graph representation (G) 310 as shown in block 326. Then, the agent 110 may sample an edge as shown in block 328 and may contract the tensor network G to generate a new tensor network G′ with a reduced dimension as shown in block 330. The contraction loss 340 associated with the sampled edge may be calculated and may be added to an accumulated contraction cost as shown in block 350. In some examples, the agent 110 may compare the dynamically updated accumulated contraction cost against C^{min}, which is the smallest observed accumulated contraction cost for a full trajectory, such that the agent 110 may determine whether to prune the current contraction path as shown in block 360, or to continue sampling of edges in the current contraction path.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

For example, the agent device may incorporate one or more processors to perform the methods or implement the techniques discussed above. In an embodiment, at least a portion of the process may be implemented using a parallel processing unit such as PPU 400, described in more detail below.

### Parallel Processing Architecture

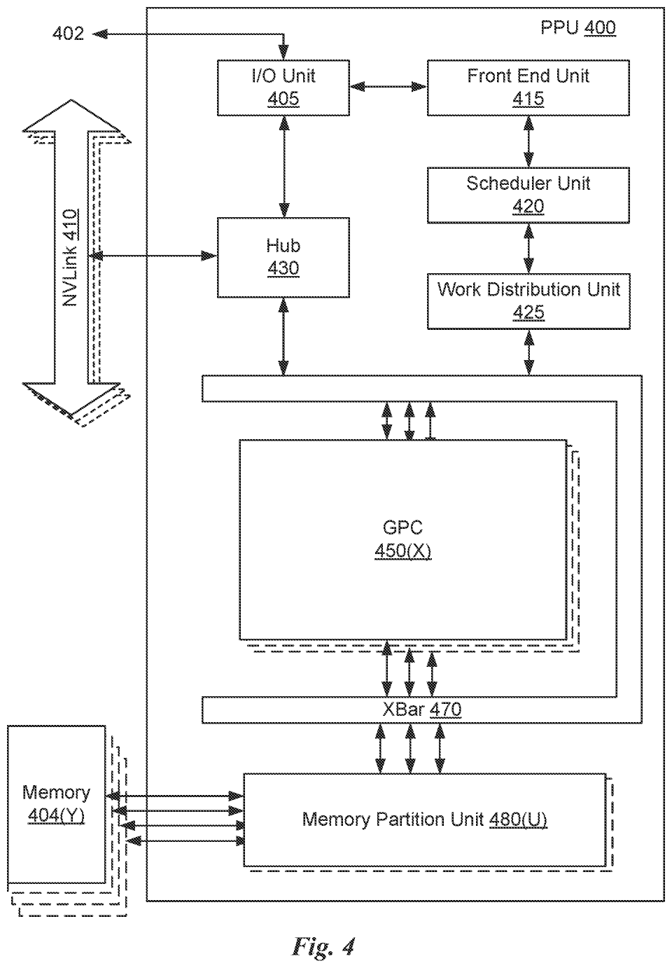

FIG. 4 illustrates a parallel processing unit (PPU) 400, in accordance with an embodiment. The PPU 400 may be used to implement any portion of the methods 200, 210, or 220 set forth above. For example, the PPU 400 may be utilized by a ray-tracing algorithm to generate images for display. The ray-tracing algorithm may generate samples for calculating lighting values of a ray, where the samples are generated using one of the techniques set forth above.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

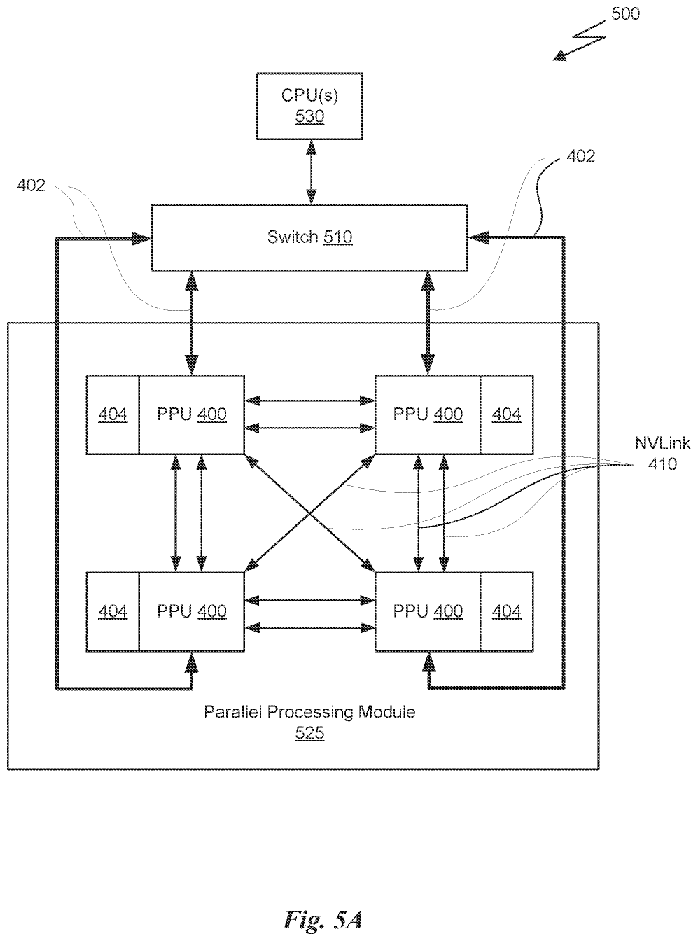

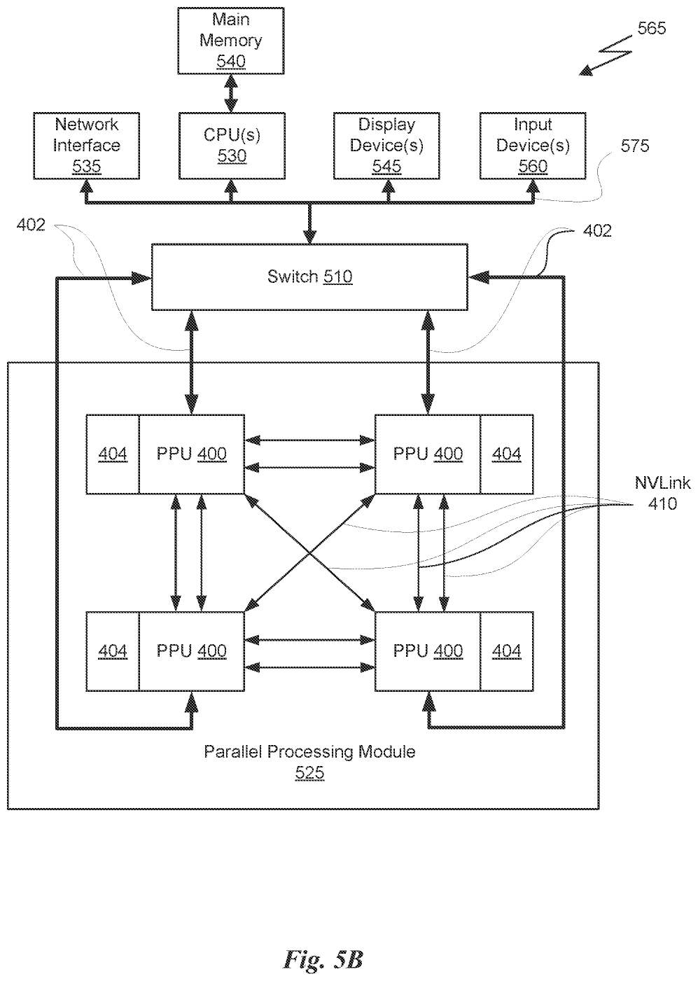

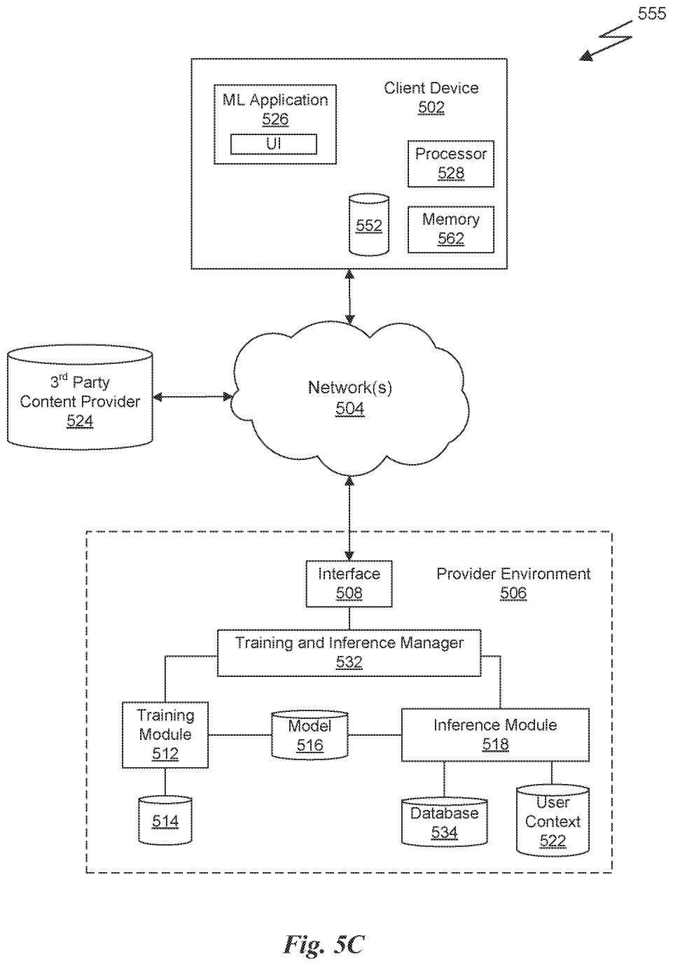

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 565 may be configured to implement the method(s) shown in FIGS. 2A-2C. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the method(s) shown in FIGS. 2A-2C.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache 460 and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

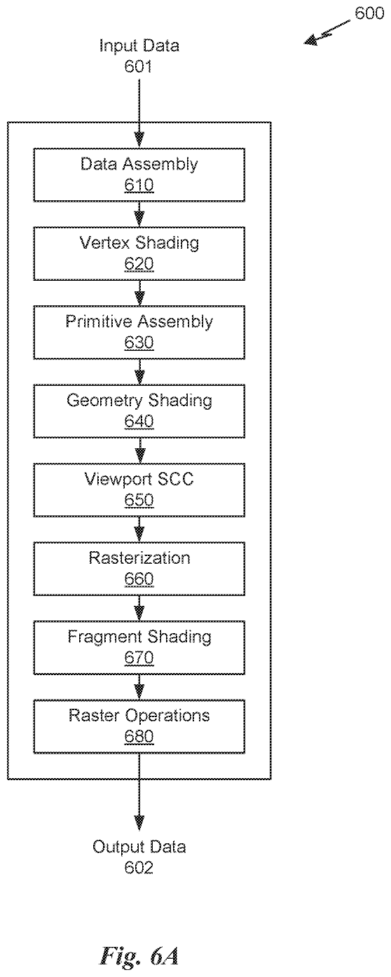

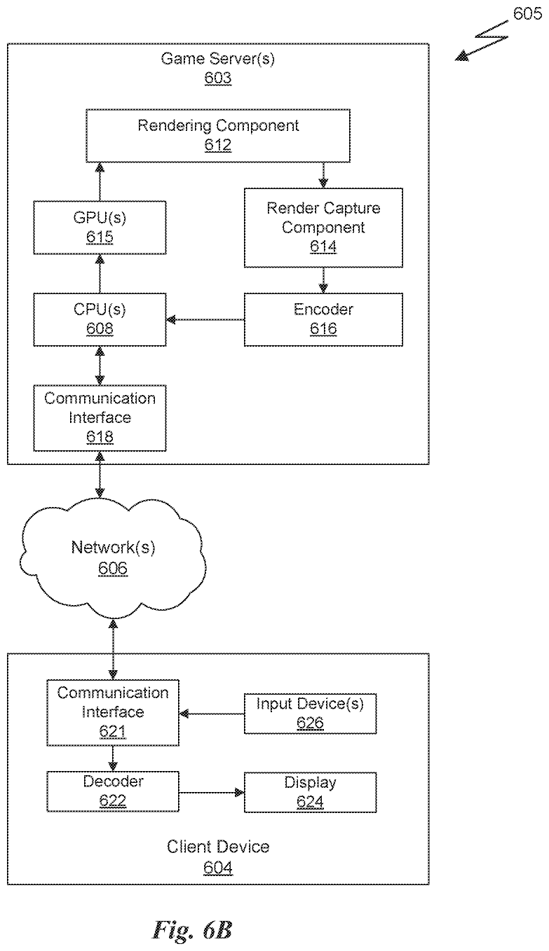

FIG. 6A is a conceptual diagram of a graphics processing pipeline 600 implemented by the PPU 400 of FIG. 4, in accordance with an embodiment. The graphics processing pipeline 600 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 600 receives input data 601 that is transmitted from one stage to the next stage of the graphics processing pipeline 600 to generate output data 602. In an embodiment, the graphics processing pipeline 600 may represent a graphics processing pipeline defined by the OpenGL® API. As an option, the graphics processing pipeline 600 may be implemented in the context of the functionality and architecture of the previous Figures and/or any subsequent Figure(s).

As shown in FIG. 6A, the graphics processing pipeline 600 comprises a pipeline architecture that includes a number of stages. The stages include, but are not limited to, a data assembly stage 610, a vertex shading stage 620, a primitive assembly stage 630, a geometry shading stage 640, a viewport scale, cull, and clip (VSCC) stage 650, a rasterization stage 660, a fragment shading stage 670, and a raster operations stage 680. In an embodiment, the input data 601 comprises commands that configure the processing units to implement the stages of the graphics processing pipeline 600 and geometric primitives (e.g., points, lines, triangles, quads, triangle strips or fans, etc.) to be processed by the stages. The output data 602 may comprise pixel data (e.g., color data) that is copied into a frame buffer or other type of surface data structure in a memory.

The data assembly stage 610 receives the input data 601 that specifies vertex data for high-order surfaces, primitives, or the like. The data assembly stage 610 collects the vertex data in a temporary storage or queue, such as by receiving a command from the host processor that includes a pointer to a buffer in memory and reading the vertex data from the buffer. The vertex data is then transmitted to the vertex shading stage 620 for processing.

The vertex shading stage 620 processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading stage 620 may manipulate individual vertex attributes such as position, color, texture coordinates, and the like. In other words, the vertex shading stage 620 performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 620 generates transformed vertex data that is transmitted to the primitive assembly stage 630.

The primitive assembly stage 630 collects vertices output by the vertex shading stage 620 and groups the vertices into geometric primitives for processing by the geometry shading stage 640. For example, the primitive assembly stage 630 may be configured to group every three consecutive vertices as a geometric primitive (e.g., a triangle) for transmission to the geometry shading stage 640. In some embodiments, specific vertices may be reused for consecutive geometric primitives (e.g., two consecutive triangles in a triangle strip may share two vertices). The primitive assembly stage 630 transmits geometric primitives (e.g., a collection of associated vertices) to the geometry shading stage 640.

The geometry shading stage 640 processes geometric primitives by performing a set of operations (e.g., a geometry shader or program) on the geometric primitives. Tessellation operations may generate one or more geometric primitives from each geometric primitive. In other words, the geometry shading stage 640 may subdivide each geometric primitive into a finer mesh of two or more geometric primitives for processing by the rest of the graphics processing pipeline 600. The geometry shading stage 640 transmits geometric primitives to the viewport SCC stage 650.

In an embodiment, the graphics processing pipeline 600 may operate within a streaming multiprocessor and the vertex shading stage 620, the primitive assembly stage 630, the geometry shading stage 640, the fragment shading stage 670, and/or hardware/software associated therewith, may sequentially perform processing operations. Once the sequential processing operations are complete, in an embodiment, the viewport SCC stage 650 may utilize the data. In an embodiment, primitive data processed by one or more of the stages in the graphics processing pipeline 600 may be written to a cache (e.g. L1 cache, a vertex cache, etc.). In this case, in an embodiment, the viewport SCC stage 650 may access the data in the cache. In an embodiment, the viewport SCC stage 650 and the rasterization stage 660 are implemented as fixed function circuitry.

The viewport SCC stage 650 performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization stage 660.

The rasterization stage 660 converts the 3D geometric primitives into 2D fragments (e.g. capable of being utilized for display, etc.). The rasterization stage 660 may be configured to utilize the vertices of the geometric primitives to setup a set of plane equations from which various attributes can be interpolated. The rasterization stage 660 may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization stage 660 generates fragment data (e.g., interpolated vertex attributes associated with a particular sample location for each covered pixel) that are transmitted to the fragment shading stage 670.

The fragment shading stage 670 processes fragment data by performing a set of operations (e.g., a fragment shader or a program) on each of the fragments. The fragment shading stage 670 may generate pixel data (e.g., color values) for the fragment such as by performing lighting operations or sampling texture maps using interpolated texture coordinates for the fragment. The fragment shading stage 670 generates pixel data that is transmitted to the raster operations stage 680.

The raster operations stage 680 may perform various operations on the pixel data such as performing alpha tests, stencil tests, and blending the pixel data with other pixel data corresponding to other fragments associated with the pixel. When the raster operations stage 680 has finished processing the pixel data (e.g., the output data 602), the pixel data may be written to a render target such as a frame buffer, a color buffer, or the like.

It will be appreciated that one or more additional stages may be included in the graphics processing pipeline 600 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 640). Other types of graphics processing pipelines are contemplated as being within the scope of the present disclosure. Furthermore, any of the stages of the graphics processing pipeline 600 may be implemented by one or more dedicated hardware units within a graphics processor such as PPU 400. Other stages of the graphics processing pipeline 600 may be implemented by programmable hardware units such as the processing unit within the PPU 400.

The graphics processing pipeline 600 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline 600 utilizing the hardware of the PPU 400.

Various programs may be executed within the PPU 400 in order to implement the various stages of the graphics processing pipeline 600. For example, the device driver may launch a kernel on the PPU 400 to perform the vertex shading stage 620 on one processing unit (or multiple processing units). The device driver (or the initial kernel executed by the PPU 400) may also launch other kernels on the PPU 400 to perform other stages of the graphics processing pipeline 600, such as the geometry shading stage 640 and the fragment shading stage 670. In addition, some of the stages of the graphics processing pipeline 600 may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now(GFN), Google Stadia, and the like.

### Example Game Streaming System

FIG. 6B is an example system diagram for a game streaming system 605, in accordance with some embodiments of the present disclosure. FIG. 6B includes game server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In the system 605, for a game session, the client device(s) 604 may only receive input data in response to inputs to the input device(s), transmit the input data to the game server(s) 603, receive encoded display data from the game server(s) 603, and display the display data on the display 624. As such, the more computationally intense computing and processing is offloaded to the game server(s) 603 (e.g., rendering—in particular ray or path tracing—for graphical output of the game session is executed by the GPU(s) of the game server(s) 603). In other words, the game session is streamed to the client device(s) 604 from the game server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the game server(s) 603. The client device 604 may receive an input to one of the input device(s) and generate input data in response. The client device 604 may transmit the input data to the game server(s) 603 via the communication interface 621 and over the network(s) 606 (e.g., the Internet), and the game server(s) 603 may receive the input data via the communication interface 618. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the game server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for contracting a tensor network, comprising:
generating a graph representation of the tensor network;
processing, by an agent that implements a reinforcement learning algorithm, the graph representation to determine a contraction for the tensor network; and
processing the tensor network in accordance with the contraction to generate a contracted tensor network.

2. The computer-implemented method of claim 1, wherein the graph representation comprises nodes and edges connecting the nodes, wherein each node represents a tensor in the tensor network, and wherein each edge represents a set of shared indices between two tensors in the tensor network.

3. The computer-implemented method of claim 1, wherein the contraction is an operation that combines two tensors in the tensor network into a product of the two tensors based on a set of shared indices, wherein the processing, by the agent that implements the reinforcement learning algorithm, the graph representation to determine the contraction for the tensor network further comprises:
determining accumulated contraction losses over one or more edges, wherein each accumulated contraction loss is an aggregation of weights on edges corresponding to a corresponding contraction path causing the tensor network to transition from an initial state into a terminal state having no edges therein; and
determining the contraction corresponding to a minimal accumulated contraction loss.

4. The computer-implemented method of claim 3, wherein the agent comprises a graph neural network (GNN) used to parameterize a policy of the reinforcement learning algorithm, and wherein the determining accumulated contraction losses over the one or more edges further comprises:
(i) determining a distribution of weights over edges for the graph representation of the tensor network;
(ii) sampling the edges by adding weights of the edges to the corresponding accumulated contraction losses and calculating graph representations of the contracted tensor network corresponding to the edges; and
(iii) repeating the steps (i) and (ii) until the calculated graph representation in the step (ii) arrives at the terminal state.

5. The computer-implemented method of claim 3, wherein the accumulated contraction losses comprise approximate values to estimate losses of a number of contractions in the respective contraction paths.

6. The computer-implemented method of claim 5, wherein the agent determines the accumulated contraction losses exceed a threshold value before calculating the number of contractions.

7. The computer-implemented method of claim 6, wherein the threshold value is the smallest observed accumulated contraction loss associated with a contraction path.

8. The computer-implemented method of claim 7, further comprising:
determining, based on the threshold value, an approximation value to estimate the loss of a number of contractions in the respective contraction loss.

9. The computer-implemented method of claim 4, wherein an off-policy element is applied in the reinforcement learning algorithm to shift the policy adopted therein towards a target policy.

10. The computer-implemented method of claim 9, wherein the off-policy element is determined based on samples drawn from an optimistic buffer, the method further comprising:
retrieving a plurality of data from the optimistic buffer;
assigning scores to each of the plurality of data;
determining, based on the distribution of the scores of the plurality of data, the samples to be drawn from the optimistic buffer;
determining the off-policy element based on the samples; and
updating the policy of the reinforcement learning algorithm.

11. The computer-implemented method of claim 1, further comprising:
extracting features from the tensor network, the features associated with a distribution;
assigning a dynamic range to one or more tails of the distribution; and
compressing the dynamic range for the one or more tails of the distribution.

12. The computer-implemented method of claim 1, wherein the agent further implements a solver, and the solver provides action scores as additional features to be learned by the reinforcement learning algorithm in the agent.

13. The computer-implemented method of claim 1, wherein the agent further implements a solver, wherein the solver calculates a number of contractions corresponding to a contraction path, and the reinforcement learning algorithm in the agent calculates the rest of the contractions in the corresponding contraction path.

14. A device implementing an agent for contracting a tensor network, comprising:
one or more processors; and
a non-transitory computer-readable medium, having computer-executable instructions stored thereon, the computer-executable instructions, when executed by the one or more processors, causing the one or more processors to:
generate a graph representation of the tensor network;
process, by the agent that implements a reinforcement learning algorithm, the graph representation to determine a contraction for the tensor network; and
process the tensor network in accordance with the contraction to generate a contracted tensor network.

15. The device of claim 14, wherein the graph representation comprises nodes and edges connecting the nodes, wherein each node represents a tensor in the tensor network, and wherein each edge represents a set of shared indices between two tensors in the tensor network.

16. The device of claim 14, wherein the contraction is an operation that combines two tensors in the tensor network into a product of the two tensors based on a set of shared indices, wherein the processing, by the agent that implements the reinforcement learning algorithm, the graph representation to determine the contraction for the tensor network further comprises:
determining accumulated contraction losses over one or more edges, wherein each accumulated contraction loss is an aggregation of weights on edges corresponding to a corresponding contraction path causing the tensor network to transition from an initial state into a terminal state having no edges therein; and
determining the contraction corresponding to a minimal accumulated contraction loss.

17. The device of claim 16, wherein the agent comprises a graph neural network (GNN) used to parameterize a policy of the reinforcement learning algorithm, and wherein the determining accumulated contraction losses over one or more edges further comprises:
(i) determining a distribution of weights over edges for the graph representation of the tensor network;
(ii) sampling the edges by adding weights of the edges to the corresponding accumulated contraction losses and calculating graph representations of the contracted tensor network corresponding to the edges; and
(iii) repeating the steps (i) and (ii) until the calculated graph representation in the step (ii) arrives at the terminal state.

18. The device of claim 17, wherein an off-policy element is applied in the reinforcement learning algorithm to shift the policy adopted therein towards a target policy.

19. The device of claim 18, wherein the off-policy element is determined based on samples drawn from an optimistic buffer, and wherein the computer-executable instructions, when executed by the one or more processors, cause the one or more processors to:
retrieve a plurality of data from the optimistic buffer;
assign scores to each of the plurality of data;
determine, based on the distribution of the scores of the plurality of data, the samples to be drawn from the optimistic buffer;
determine the off-policy element based on the samples; and
update the policy of the reinforcement learning algorithm.

20. A non-transitory computer-readable medium implementing an agent, having computer-executable instructions stored thereon, for model training, the computer-executable instructions, when executed by one or more processors, causing the one or more processors to:
generate a graph representation of the tensor network;
process, by the agent that implements a reinforcement learning algorithm, the graph representation to determine a contraction for the tensor network; and
process the tensor network in accordance with the contraction to generate a contracted tensor network.

21. The computer-implemented method of claim 3, wherein the reinforcement learning algorithm is trained based on, at least in part, a parameter associated with a processor configured to perform the contraction operation.

22. The computer-implemented method of claim 4, wherein the GNN is configured to generate:
(i) the distribution of weights over edges for the graph representation of the tensor network; and
(ii) for each edge, a corresponding probability p that is used to determine whether to perform a slicing operation.

23. The device of claim 16, wherein the reinforcement learning algorithm is trained based on, at least in part, a parameter associated with a processor configured to perform the contraction operation.

24. The device of claim 17, wherein the GNN is configured to generate:
(i) the distribution of weights over edges for the graph representation of the tensor network; and
(ii) for each edge, a corresponding probability p that is used to determine whether to perform a slicing operation.
